(19) United States
(12) Patent Application Publication
(10) Pub. No.: US 2007/0189609 A1
(43) Pub. Date: Aug. 16, 2007

(54) Method, apparatus, and program for discriminating faces

(75) Inventors: Wataru Ito, Kanagawa-ken (JP); Sadato Akahori, Kanagawa-ken (JP); Kensuke Terakawa, Kanagawa-ken (JP); Yoshiro Kitamura, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/393,680

(22) Filed: Mar. 31, 2006

(30) Foreign Application Priority Data
Mar. 31, 2005 (JP) 103780/2005

(51) Int. Cl. G06K 9/62; G06K 9/46

(52) U.S. Cl. 382/224; 382/195

(57) ABSTRACT

A face discriminating process judges whether a discrimination target image is an image of a face, based on characteristic amounts of the discrimination target image. Gradation conversion of pixel values is administered as a preliminary process, to suppress fluctuations in contrast within the discrimination target image. In the gradation conversion process, degrees of variance of pixel values within local regions of the discrimination target image are caused to approach a predetermined level. The local regions are set to be of a size that includes a single eye of a face to be discriminated.

### BACKGROUND OF THE INVENTION

1. Field of the Invention

The present invention relates to a method, an apparatus, and a program for discriminating whether a target image is an image of a face.

2. Description of the Related Art

Correction of skin tones in snapshots photographed with digital cameras by investigating color distributions within facial regions, and recognition of people who are pictured in digital images obtained by digital video cameras of security systems is being performed. In these cases, it is necessary to detect regions (facial regions) within digital images that correspond to people's faces. For this reason, various techniques have been proposed, for discriminating whether a target image represents a face.

For example, U.S. Patent Application Publication No. 20050100195 disclose methods for discriminating that discrimination target images are images that represent a predetermined subject. These methods obtain characteristic amounts, which are calculated from a plurality of sample images, which are known to be of the predetermined subject, and a plurality of sample images, which are known to not be of the predetermined subject, in advance with a machine learning technique. Thereby, a plurality of discriminators that output reference values for discriminating whether a discrimination target image is an image of the predetermined subject, by inputting the characteristic amounts thereof, are obtained. The discrimination target image is discriminated to be an image that represents the predetermined subject in the case that the weighted total of the reference values output from the plurality of discriminators exceeds a predetermined threshold value.

S. Lao et al., “Fast Omni-Directional Face Detection”,

Meeting of Image Recognition and Understanding, pp. II271-II276, 2004 discloses a method for detecting faces employing a plurality of weak classifiers, which are linearly linked in a cascade configuration. The weak classifiers for discriminating whether a discrimination target image is an image that represents a face are obtained by machine learning, employing a plurality of sample images, which are known to be of the predetermined subject, and a plurality of sample images, which are known to not be of the predetermined subject. In this method, it is discriminated that the discrimination target image is an image that represents a face in the case that all of the weak classifiers judge that the discrimination target image is an image that represents a face. Note that in these methods, it is often the case that the characteristic amounts employed are those related to the brightness distributions of the discrimination target images.

Snapshots obtained by digital cameras or the like and images read out by scanners are included in the discrimination target images. There are cases in which contrast (degrees of light and dark) in these images vary, due to photography scenes or photographic conditions, as well as hardware properties. If discrimination based on characteristic amounts related to the brightness distributions of images in which the contrast is not constant, the characteristic amounts do not appropriately reflect the likelihood that the images represent faces. Therefore, the accuracy of discrimination is reduced.

Accordingly, there is a known method for normalizing variance of pixel values that represent brightness to a predetermined level suitable for discrimination. This method calculates the variance of pixel values within the entire discrimination target image, and normalizes the entire image with a single parameter, which is obtained based on the calculated variance.

However, by administering the above method, in which the variance of pixel values is calculated and then normalizing the degree of variance of pixel values based on a single parameter, the normalization becomes unstable in the case that the discrimination target image is a facial image. This is because the normalization is affected by density variations of regions within the images other than faces. For example, others object may overlap portions of faces, oblique light (a state in which light is incident on the face at an oblique angle) may be present due to lighting conditions, or density fluctuations may be present in background regions other than the faces. If density fluctuations are present, the variance of pixel values within the entire discrimination target image are affected, and there are cases in which desired normalization cannot be performed. If discrimination based on characteristic amounts related to the brightness distributions of images which have been normalized as described above, the characteristic amounts do not appropriately reflect the likelihood that the images represent faces. Therefore, the accuracy of discrimination is reduced.

### SUMMARY OF THE INVENTION

The present invention has been developed in view of the foregoing circumstances. It is an object of the present invention to provide a method, an apparatus, and a program for detecting faces, which are capable of suppressing reduction in accuracy of discrimination.

The face discriminating method of the present invention comprises:

a normalizing step for suppressing fluctuations in contrast within a discrimination target image, which is a target of discrimination regarding whether the image is a facial image, by administering brightness gradation conversion to cause degrees of variance of pixel values that represent values within local regions within the discrimination target image to approach a first predetermined level; and

a face discriminating step for calculating at least one characteristic amount related to the brightness distribution of the discrimination target image, on which the normalizing step has been administered, and discriminating whether the discrimination target image is a facial image by employing the characteristic amount;

the local regions being of a size that includes only one eye of a face to be discriminated by the face discriminating step.

The face discriminating apparatus of the present invention comprises:

normalizing means for administering a normalizing process to suppress fluctuations in contrast within a discrimination target image, which is a target of discrimination regarding whether the image is a facial image, by administering brightness gradation conversion to cause degrees of variance of pixel values that represent values within local regions within the discrimination target image to approach a first predetermined level; and

face discriminating means for calculating at least one characteristic amount related to the brightness distribution of the discrimination target image, on which the normalizing step has been administered, and discriminating whether the discrimination target image is a facial image by employing the characteristic amount;

the local regions being of a size that includes only one eye of a face to be discriminated by the face discriminating step.

The program of the present invention causes a computer to execute:

a normalizing procedure for suppressing fluctuations in contrast within a discrimination target image, which is a target of discrimination regarding whether the image is a facial image, by administering brightness gradation conversion to cause degrees of variance of pixel values that represent values within local regions within the discrimination target image to approach a first predetermined level; and

a face discriminating procedure for calculating at least one characteristic amount related to the brightness distribution of the discrimination target image, on which the normalizing step has been administered, and discriminating whether the discrimination target image is a facial image by employing the characteristic amount;

the local regions being of a size that includes only one eye of a face to be discriminated by the face discriminating procedure.

In the present invention, the normalizing process may comprise the steps of:

sequentially setting each pixel within the discrimination target image as a pixel of interest;

calculating degrees of variance within local regions of a predetermined size, of which the pixels of interest are representative pixels; and

causing the differences between the pixel values of the pixels of interest and predetermined statistical representative pixel values of the local regions to become smaller, as the difference between the degrees of variance and a reference value corresponding to the first predetermined level become greater when the degrees of variance are greater than the reference value, and causing the differences between the pixel values of the pixels of interest and the predetermined statistical representative pixel values of the local regions to become greater, as the difference between the degrees of variance and the reference value become greater, when the degrees of variance are less than the reference value.

In the present invention, the face discriminating means may perform learning, employing sample facial images, in which the directions that the faces pictured therein are facing and the vertical orientations thereof are the same; and

the local regions may be regions having widths which are 1.1 to 1.8 times the average width of the widths of eyes included in the sample facial images.

In this case, the face discriminating means may comprise a plurality of different weak classifiers (modules) for discriminating whether the discrimination target image is a facial image, which are linearly linked in order of reliability thereof.

Here, the “degree of variance of pixel values” refers to the degree of fluctuation among pixel values. The degree of variance of pixel values may be a mathematical variance value of the pixel values, or a difference between the maximum and minimum pixel values, for example. The “first predetermined level” is one of the values that the difference between the maximum and minimum pixel values may assume, and may be the variance value or the difference. The first predetermined level may be the variance value or the difference of a region corresponding to a border between a portion of the image at which the contrast is flat to begin with, such as foreheads, cheeks, or backgrounds, and other portions of the image.

Note that the first predetermined level should be set according to noise levels, which are different for each image. It is preferable to set the first predetermined level according to an input source of the image, in case that the input source is known. For example, images photographed by imaging means built into cellular telephones have relatively large amounts of noise. Therefore, the first predetermined level is set to be high in this case, in order to suppress noise amplification. In the case that the noise level of an image is known, from analysis by a noise analyzing means or gain data at the time of imaging obtained by an imaging means, the first predetermined level may be set high when the noise level is high, and set low when the noise level is low.

The “local regions of a predetermined size, of which the pixels of interest are representative pixels” are set as regions Z1 having a pixel of interest x as its approximate center or its approximate center of gravity, as illustrated in FIGS. 16A, 16B, and 16C. Alternatively, the “local regions of a predetermined size, of which the pixels of interest are representative pixels” are regions Z2, which are regions within the regions Z1, set according to the distributions of pixel values within the regions Z1. In the case that a histogram of pixel values within a region Z1 has multiple peaks, as illustrated in FIG. 17, a region corresponding to the pixels within the peak that a pixel value X of the pixel of interest x is included may be set as a region Z2. That is, a region of the region Z1, from which a region Za constituted by pixels corresponding to the peak that does not include the pixel value X is removed, may be set as the region Z2. This manner of setting regions is often employed when the region Z1 clearly straddles regions having different levels of image density. Thereby, adverse influence due to the border of the density difference can be avoided, and calculations of pixel values can be performed only with respect to an image within a predetermined region.

The “predetermined statistical representative pixel values” is a central value that represents the characteristic of the distribution of pixel values. The statistical representative pixel value may be an mean value, a median value, an intermediate value, or a mode value, for example.

For the sake of convenience, it is preferred that the “local regions” are rectangular regions. However, the local regions may be circular regions or oval regions.

In the present invention, the “sample facial images” to be employed during learning only need to include at least the sample facial images for learning described above. Non facial images of subjects other than faces may also be employed as images for learning.

The “sample facial images” refer to sample images, which are known to be of faces and employed during learning. The “non facial images” refer to sample images, which are known to not be of faces and employed during learning.

The “vertical orientations” of the sample facial images are not limited to those which are completely matched. Faces, which are rotated in the plane of the image within a predetermined angular range, for example, ±15 degrees, are included in an allowable range.

The “weak classifiers” are discriminating means (modules) that have correct discrimination rates exceeding 50%. That the weak classifiers are “linearly linked” refers to a configuration in which the weak classifiers are connected in series. In this configuration, if a discrimination target image is discriminated to be a facial image by a weak classifier, the discrimination target image is discriminated by a next weak classifier, and if a discrimination target image is discriminated to be a non facial image by a weak classifier, the discrimination process is aborted. Discrimination target images, which are discriminated to be facial images by the last weak classifier in the series, are ultimately discriminated to be facial images.

Note that the face discriminating program of the present invention may be provided being recorded on a computer readable medium. Those who are skilled in the art would know that computer readable media are not limited to any specific type of device, and include, but are not limited to: floppy disks; RAM's; ROM's; CD's; magnetic tapes; hard disks; and internet downloads, by which computer instructions may be transmitted. Transmission of the computer instructions through a network or through wireless transmission means is also within the scope of the present invention. In addition, the computer instructions may be in the form of object, source, or executable code, and may be written in any language, including higher level languages, assembly language, and machine language.

The method, apparatus, and program for discriminating faces of the present invention suppress fluctuations in contrast within discrimination target images, by administering normalizing processes that perform gradation conversion on pixel values. The gradation conversion is performed such that the variance of pixel values in local regions within the discrimination target images approaches the first predetermined level. The local regions are defined to be of a size that includes only one eye of faces to be discriminated. Therefore, changes in contrast within characteristic components of faces, such as eyes and noses, are suppressed, thereby enabling stable normalization which is not influenced by fluctuations in density due to objects overlapping faces, oblique light, or backgrounds. Accordingly, the characteristic amounts related to the brightness distribution of a discrimination target image accurately reflect the likelihood of being a facial image, and deterioration in discrimination accuracy can be suppressed.

### BRIEF DESCRIPTION OF THE DRAWINGS

FIG. 1 is a schematic block diagram that illustrates the construction of a face detecting system.

FIG. 2 is a diagram that illustrates the process by which multiple resolution images are generated for extraction target images.

FIG. 3 is a block diagram that illustrates the construction of a first face detecting section.

FIG. 4 is a block diagram that illustrates the construction of a second face detecting section.

FIG. 5 is a flow chart that illustrates an outline of the processes performed by a classifier.

FIG. 6 is a flow chart that illustrates the processes performed by the weak classifiers within the classifier.

FIG. 7 is a diagram for explaining calculation of characteristic amounts by the weak classifiers.

FIG. 8 is a diagram for explaining rotation of resolution images having different resolutions, and movement of a subwindow.

FIG. 9 is a flow chart that illustrates the processes performed by the face detecting system.

FIG. 10 is a flow chart that illustrates a learning method of the classifier.

FIG. 11 is a diagram that illustrates a method by which histograms of the weak classifiers are derived.

FIG. 12 is a diagram that illustrates the concept of a local region normalizing process.

FIG. 13 is a flow chart that illustrates the processes performed by a local region normalizing section.

FIG. 14 illustrates a sample image, which has been standardized such that eyes pictured therein are at predetermined positions.

FIG. 15 illustrates an example of a local region of a size that employs the size of an eye as a reference.

FIGS. 16A, 16B, and 16C illustrate examples of local regions having a pixel of interest as a representative pixel.

FIG. 17 illustrates an example of local regions having a pixel of interest as a representative pixel, which are set based on the distribution of pixel values.

### DESCRIPTION OF THE PREFERRED EMBODIMENTS

Hereinafter, an embodiment of the present invention will be described. FIG. 1 is a schematic block diagram that illustrates the construction of a face detecting system 1, to which the face discriminating apparatus of the present invention has been applied. The face detecting system 1 detects faces included in digital images, regardless of the position, the size, the facing direction, and the rotational direction thereof. As illustrated in FIG. 1, the face detecting system 1 comprises: a multiple resolution image generating section 10, for converting the resolution of input images S0, which are target images in which faces are to be detected, to obtain a plurality of images S1_{—}i (i=1, 2, 3 . . . ) having different resolutions (hereinafter, referred to as “resolution images”); a local region normalizing section 20 (normalizing means), for administering normalization (hereinafter, referred to as “local region normalization”) to suppress fluctuations in contrast of each local region within the entirety of the resolution images S1_{—}i, to obtain a plurality of resolution images S1′_{—}i, on which local region normalization has been administered, as a preliminary process that improves the accuracy of a face detecting process to be executed later; a first face detecting section 30, for administering a rough face detecting process on each of the locally normalized resolution images S1′_{—}i, to extract face candidates S2; a second face detecting section 40, for administering a highly accurate face detecting process on images within the vicinities of the face candidates S2, to obtain faces S3, which are believed to be true faces; and a redundant detection discriminating section 50, for organizing each of the faces S3 detected in each of the resolution images S′1_{—}i, by discriminating whether the same face has been redundantly detected based on the positional relationships therebetween, to obtain faces S′3, which have not been redundantly detected.

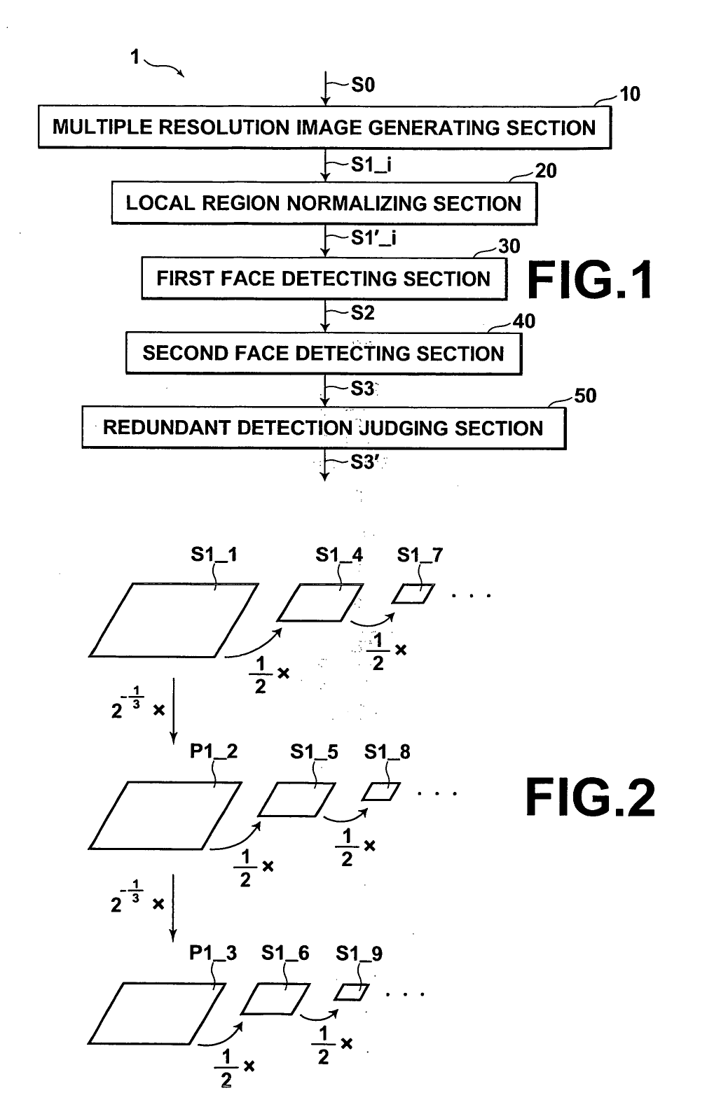

The multiple resolution image generating section 10 converts the resolution (image size) of the input image S0, to standardize the resolution to a predetermined resolution, for example, a rectangular image having 416 pixels per side, to obtain a standardized input image S1. Then, resolution conversion is administered, using the image S1 as the basic image, to generate the plurality of resolution images S1_{—}i having different resolutions. The reason for generating the plurality of resolution images S1_{—}i is as follows. Generally, the sizes of faces which are included in the input image S0 is unknown. However, it is necessary for the sizes of faces (image size) to be detected to be uniform, due to the configuration of classifiers, to be described later. Therefore, partial images of a predetermined size are cut out from images having different resolutions, and discriminations are performed regarding whether the partial images represent faces or subjects other than faces. Specifically, the standardized input image S1 is employed as a basic image S1_1, which is multiplied by 2^{-1/3}, to obtain an image S1_2, as illustrated in FIG. 2. The image S1_2 is multiplied by 2^{-1/3}, to obtain an image S1_3. Thereafter, reduced images S1_4, S1_5, and S1_6, which are ½ the size of the original images, are generated for each of the images S1_1, S1_2, and S1_3, respectively. Further, reduced images S1_7, S1_8, and S1_9, which are ½ the sizes of the reduced images S1_4, S1_5, and S1_6, respectively, are generated. The generation of reduced images is repeated until a predetermined number of reduced images are obtained. Reduced images, which are 2^{-1/3} times the resolution of ½ size reduced images, which do not require interpolation of pixel values that represent brightness, can be generated quickly by this method of reduced image generation. Note that the images, which are generated without interpolating pixel values, tend to bear the characteristics of the image patterns of the original images. Therefore, these reduced images are preferable from the viewpoint of improving the accuracy of the face detecting process.

The local region normalizing section 20 administers a first brightness gradation converting process and a second brightness gradation converting process on each of the resolution images S1_{—}i. The first brightness gradation converting process causes degrees of variance of pixel values representing brightness, which are greater than or equal to a first predetermined level, to approach a second predetermined level, which is higher than the first predetermined level, for each of a plurality of local regions within the resolution images S1_{—}i. The second brightness gradation converting process causes degrees of variance of pixel values representing brightness, which are less than the first predetermined level, to be suppressed such that it is lower than the second predetermined level, for each of a plurality of local regions within the resolution images S1_{—}i. Here, the specific processes performed by the local region normalizing section 20 will be described.

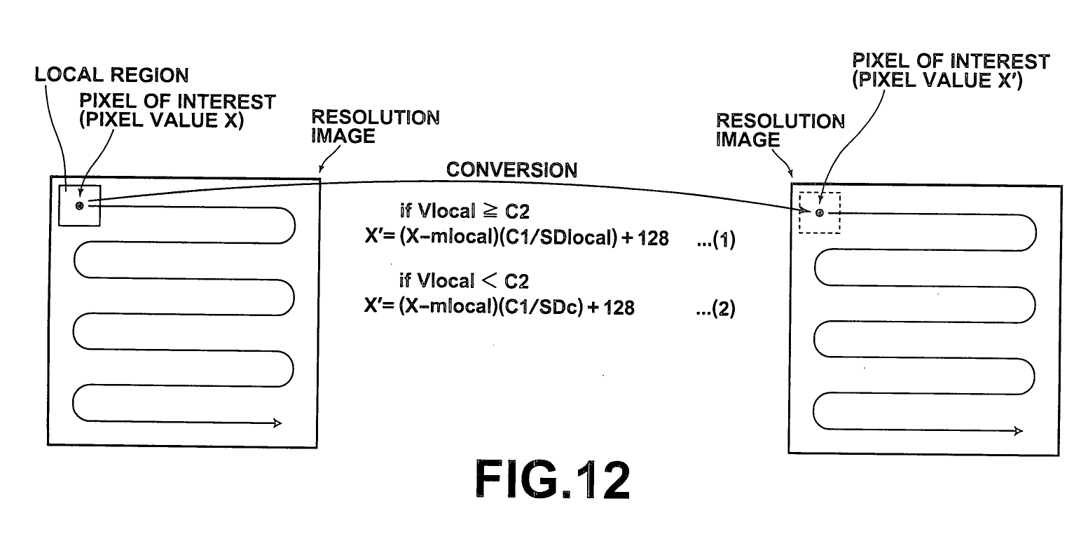

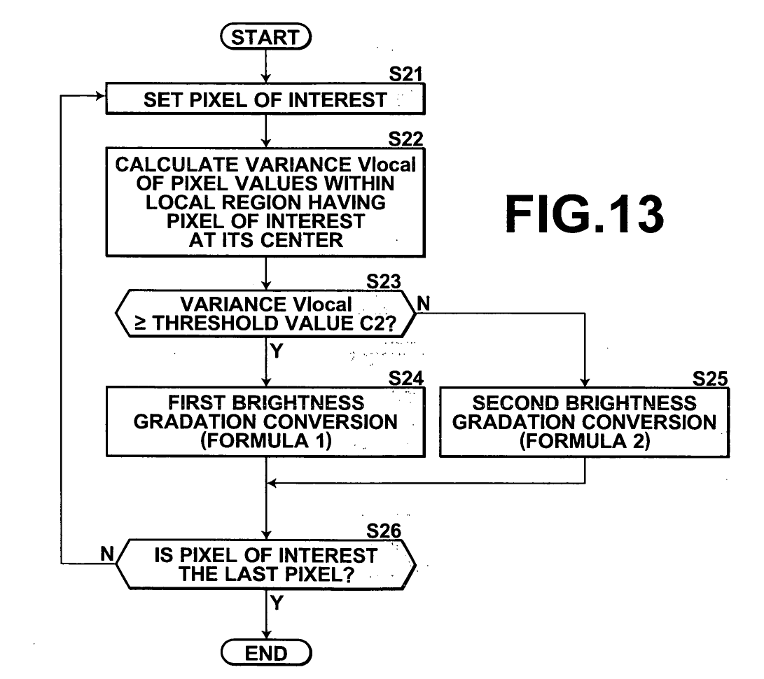

FIG. 12 is a diagram that illustrates the concept of a local region normalizing process, and FIG. 13 is a flow chart that illustrates the processes performed by the local region normalizing section 20. Formulas (1) and (2) are formulas for converting the gradations of pixel values in the local region normalizing process.

If Vlocal≧C2
X′=(X−mlocal)(C1/SDlocal)+128 (1)

If Vlocal<C2
X′=(X−mlocal)(C1/SDc)+128 (2)
wherein:
X: pixel value of a pixel of interest;
X′: pixel value after conversion;
mlocal: mean pixel value within a local region having the pixel of interest as its center;
Vlocal: variance of pixel values within the local region;
Sdlocal: standard deviation of pixel values within the local region;
(C1×C1): reference value;
C2: threshold value; and
SDc: constant

Here, X represents the pixel value of a pixel of interest; X′ represents the pixel value of the pixel of interest after conversion; mlocal represents a mean pixel value within a local region having the pixel of interest as its center; Vlocal represents the variance of pixel values within the local region; SD local represents the standard deviation of pixel values within the local region; (C1×C1) represents a reference value that corresponds to the second predetermined level; C2 represents a threshold value that corresponds to the first predetermined level; and SDc is a predetermined constant. Note that the number of brightness gradations is expressed as 8 bit data, and that the pixel values range from 0 to 255 in the present embodiment.

As illustrated in FIG. 13, the local region normalizing section 20 sets a pixel within a resolution image as a pixel of interest (step S21). Next, the variance Vlocal, among pixel values within a local region of a predetermined size, for example, 11×11 pixels, having the pixel of interest at its center, is calculated (step S22). Then, it is judged whether the calculated variance Vlocal is greater than or equal to a threshold value C2 that corresponds to the first predetermined level (step S23). In the case that the discrimination results of step S23 indicate that the variance Vlocal is greater than or equal to the threshold value C2, the first brightness gradation converting process is administered according to Formula (1) (step S24). The first brightness gradation converting process causes the difference between the pixel value X of the pixel of interest and the mean value mlocal to become smaller, as the difference between the variance Vlocal and the reference value (C1×C1) corresponding to the second predetermined level become greater when the variance Vlocal is greater than the reference value, and causes the difference between the pixel value X of the pixel of interest and the mean value mlocal to become greater, as the difference between the variance Vlocal and the reference value (C1×C1) become greater when the variance Vlocal is less than the reference value. On the other hand, in the case that the variance Vlocal is judged to be less than the threshold value C2, a linear gradation conversion, which does not depend on the variance Vlocal, is administered according to Formula (2), as the second brightness gradation converting process (step S25). Thereafter, it is discriminated whether the pixel of interest set in step S21 is the last pixel (step S26). If it is discriminated that the pixel of interest is not the last pixel in step S26, the process returns to step 21, and a next pixel within the resolution image is set as the pixel of interest. On the other hand, if it is discriminated that the pixel of interest is the last pixel in step S26, the local region normalizing process for the resolution image ends. By repeating the processes performed in steps S21 through S26 in this manner, a resolution image, on which the local region normalizing process has been administered, is obtained. The local region normalized resolution images S1′_{—}i are obtained, by administering the sequence of processes on each of the resolution images S1_{—}i.

Note that the first predetermined level may be varied according to the brightness of the entirety or a portion of the local regions. For example, the threshold value C2 may be varied according to the pixel value of the pixel of interest. That is, the threshold value C2 corresponding to the first predetermined level may be set to be high when the brightness of the pixel of interest is relatively high, and set low when the brightness of the pixel of interest is relatively low. By setting the threshold value C2 in this manner, faces, which are present within regions having low brightness, that is, dark regions with low contrast (a state in which the variance of pixel values is low) can also be correctly normalized.

Here, a case is described in which only local region normalizing processes are administered on the resolution images. Alternatively, different normalization processes may be performed as well. For example, gradation conversion may be administered employing an LUT (Look Up Table), which is designed to increase contrast (to increase the variance of pixel values) in regions having low brightness, that is, dark regions. Then, the aforementioned local normalizing processes may be administered. By performing the gradation conversion employing the LUT, the same effects as those obtained by varying the threshold value C2 according to the pixel value of the pixel of interest can be obtained. That is, faces, which are present within dark regions with low contrast can also be correctly normalized.

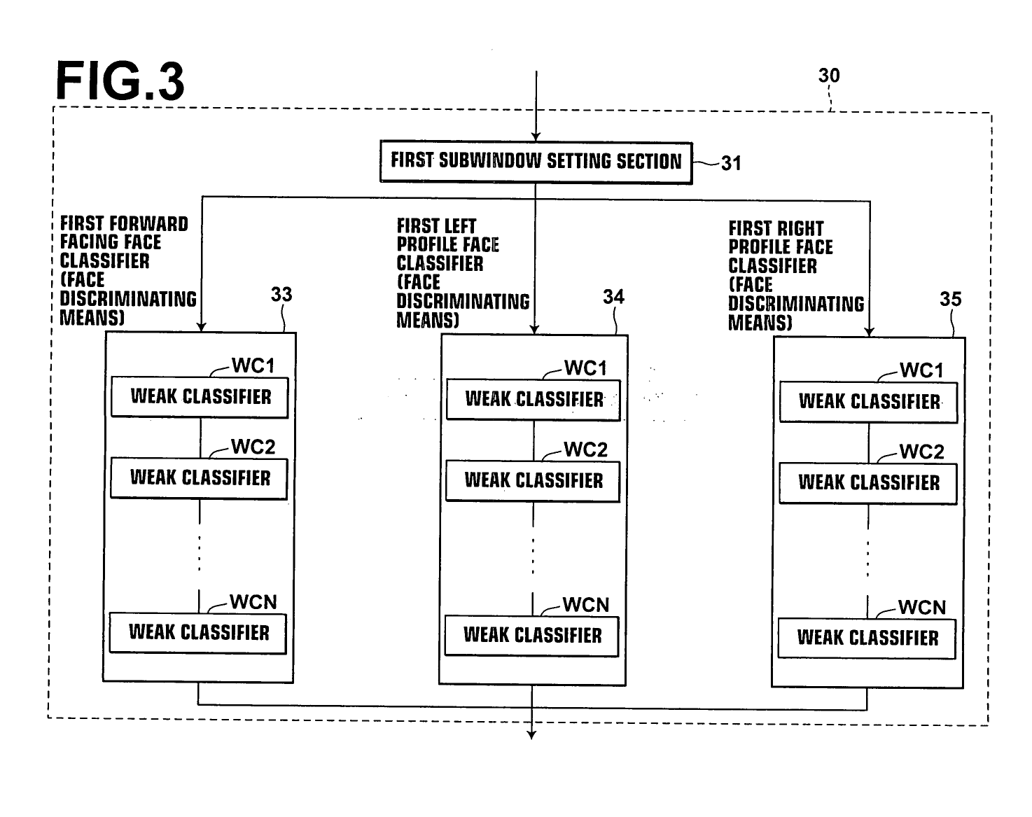

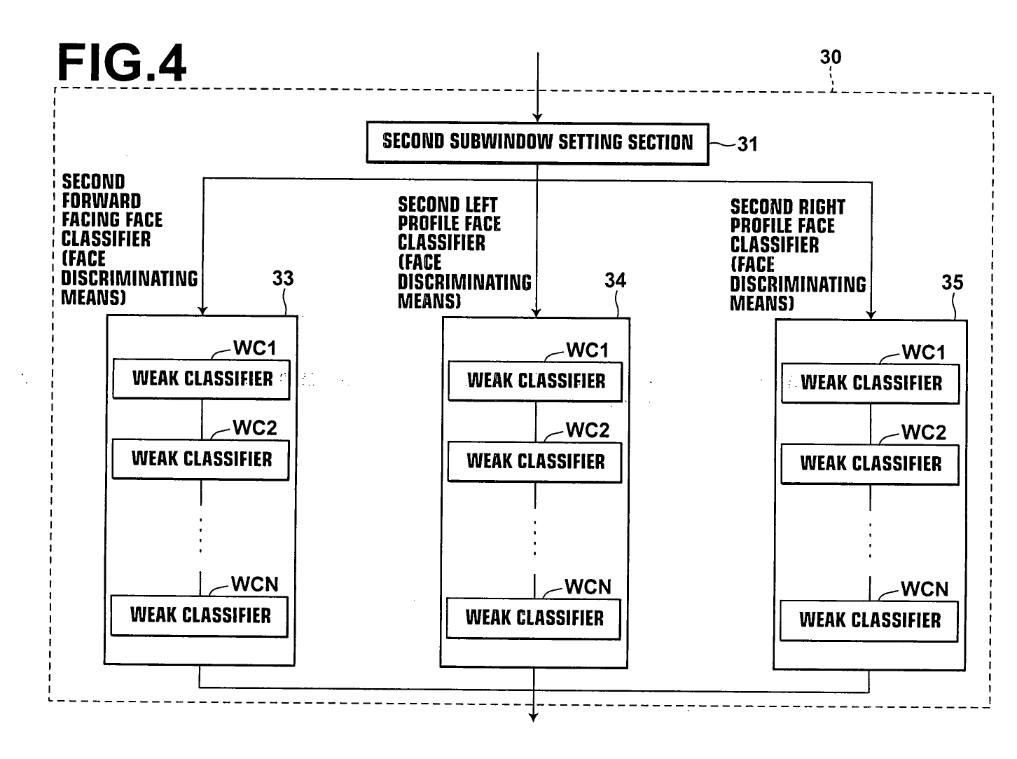

The first face detecting section 30 administers a rapid and comparatively rough face detecting process on each of the resolution images S1′_{—}i, on which the local region normalizing processes have been administered, to extract preliminary face candidates S2 therefrom. FIG. 3 is a block diagram that illustrates the construction of the first face detecting section 30. As illustrated in FIG. 3, the first face detecting section 30 comprises: a first subwindow setting section 31, for sequentially setting subwindows W for cutting out partial images (discrimination target images), which become targets of discrimination regarding whether a face is pictured therein, within each resolution image; a first forward facing face classifier 33 (face discriminating means), for discriminating whether a partial image represents a forward facing face; a first left profile face classifier 34 (face discriminating means), for discriminating whether a partial image represents a left profile of a face; and a first right profile face classifier 35 (face discriminating means), for discriminating whether a partial image represents a right profile of a face. Each of the classifiers 33 through 35 are constituted by a plurality of weak classifiers WCi (i=1 through N), which are linearly linked in a cascade configuration.

The first subwindow setting section 31 sequentially sets subwindows W for cutting out 32×32 pixel partial images, while rotating each of the resolution images S1′_{—}i 360 degrees within the plane of each image and moving the position of the subwindow W a predetermined distance, for example, 5 pixels. The first subwindow setting section 31 outputs the cut out partial images to the first forward facing face classifier 33, the first left profile face classifier 34, and the first right profile face classifier 35.

The classifiers 33 through 35 judge whether each of the sequentially input partial images are forward facing faces, left profiles of faces, or right profiles of faces. Thereby, forward facing faces, left profiles of faces, and right profiles of faces, which are at rotated at various angles within the resolution images S1′_{—}i are detected, and output as face candidates S2. Note that classifiers for discriminating leftward obliquely facing faces and rightward obliquely facing faces may be provided, to improve the detection accuracy for obliquely facing faces. However, they are not provided in the present embodiment.

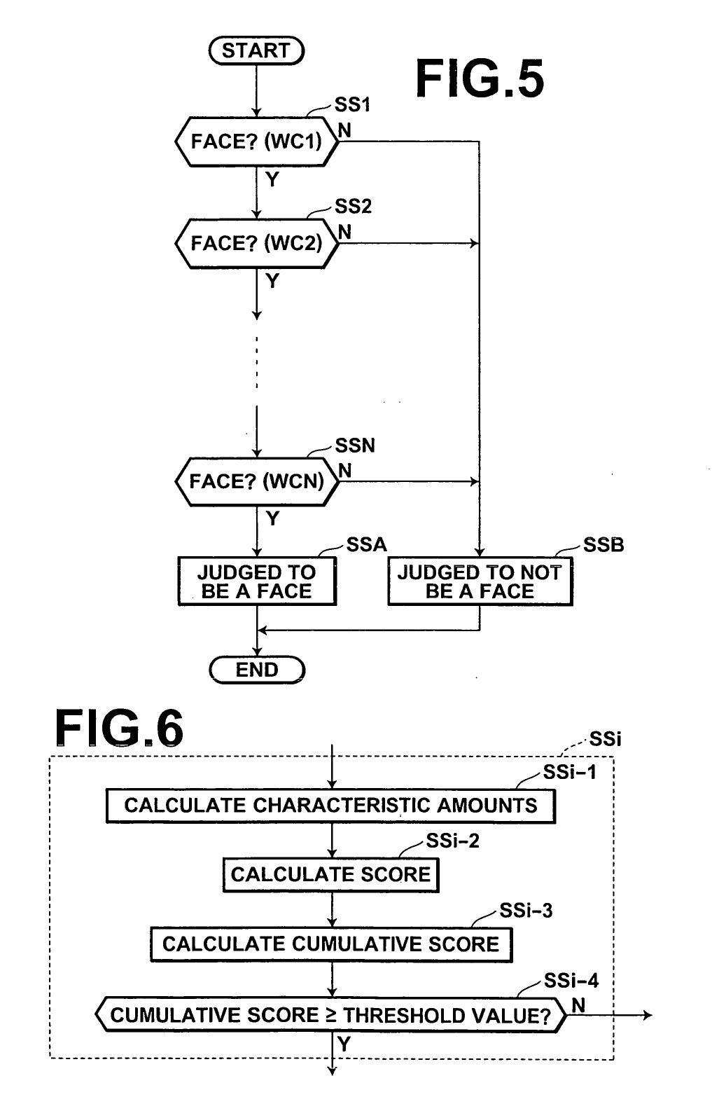

The classifiers 33 through 35 calculate at least one characteristic amount related to the brightness distributions of the partial images, and judge whether the partial images are facial images employing the characteristic amount. Here, the specific processes performed by each of the classifiers 33 through 35 will be described with combined reference to FIG. 5 and FIG. 6. FIG. 5 is a flow chart that illustrates an outline of the processes performed by each of the classifiers 33 through 35. FIG. 6 is a flow chart that illustrates the processes performed by the weak classifiers within the classifiers 33 through 35.

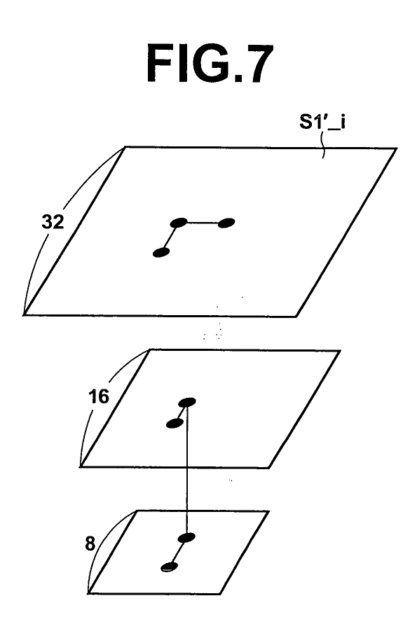

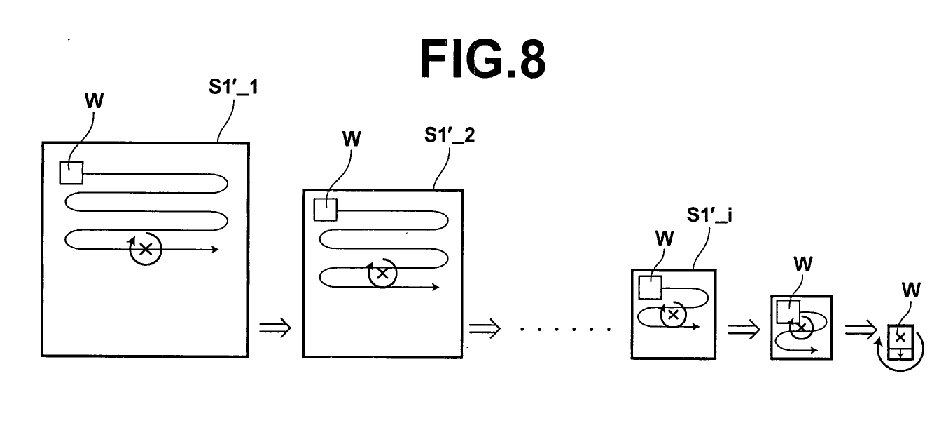

First, the first weak classifier WC1 judges whether a partial image of the predetermined size, which has been cut out from a resolution image S1′_{—}i, represents a face (step SS1). Specifically, the weak classifier WC1 obtains a 16×16 pixel size image and an 8×8 pixel size image as illustrated in FIG. 7, by administering a four neighboring pixel average process twice. The four neighboring pixel average process sections the partial image into 2×2 pixel blocks, and assigns the average pixel values of the four pixels within the blocks as the pixel value of pixels that correspond to the blocks. Pairs of points are set within the three images. The differences between the pixel values of points of each pair within a pair group constituted by a plurality of different types of pairs are calculated, and the combinations of the differences are designated to be the characteristic amounts (step SS1-1). The two points that constitute each pair may be two predetermined points which are aligned in the vertical direction or the horizontal direction so as to reflect density characteristics of faces within images. A score is calculated based on the combinations of the differences, by referring to a predetermined score table (step SS1-2). The calculated score is added to a score which has been calculated by the immediately preceding weak classifier, to calculate a cumulative score (step SS1-3). However, the first weak classifier WC1 does not have a preceding weak classifier, and therefore, the score calculated by itself is designated to be the cumulative score. Whether the partial image represents a face is discriminated, based on whether the cumulative score is greater than or equal to a predetermined threshold value (step SS1-4). Here, in the case that the partial image is discriminated to represent a face, the partial image is output to the next weak classifier WC2 to be discriminated thereby (step SS2). In the case that the partial image is discriminated to not represent a face, the partial image is identified to not represent a face (step SSB), and the processes end.

In step SS2, the weak classifier WC2 calculates characteristic amounts that represent characteristics of the partial image (step SS2-1), and calculates a score by referring to the score table (step SS2-2), in a manner similar to that of step SS1. Then, the cumulative score is updated, by adding the calculated score to the cumulative score calculated by the preceding weak classifier WC1 (step SS2-3). Thereafter, whether the partial image represents a face is discriminated, based on whether the cumulative score is greater than or equal to a predetermined threshold value (step SS2-4). Here as well, in the case that the partial image is discriminated to represent a face, the partial image is output to the next weak classifier WC3 to be discriminated thereby (step SS3). In the case that the partial image is discriminated to not represent a face, the partial image is identified to not represent a face (step SSB), and the processes end. If the partial image is discriminated to represent a face by all N weak classifiers, the partial image is ultimately extracted as a face candidate (step SSA).

Each of the classifiers 33 through 35 comprises a plurality of weak classifiers having types of characteristic amounts, score tables, and threshold values, which are unique thereto. The classifiers 33 through 35 judge whether partial images are faces facing forward, facing left, and facing right, respectively.

The second face detecting section 40 administers a face detecting process having comparatively high accuracy on predetermined regions within images that include face candidates S2, to extract true faces S3 from the images in the vicinities of the face candidates S2. The basic construction of the second face detecting section 40 is the same as that of the first face detecting section 30. The second face detecting section 40 comprises: a second subwindow setting section 41; a second forward facing face classifier 43; a second left profile face classifier 44; and a second right profile face classifier 45. Each of the classifiers 43 through 45 are constituted by a plurality of weak classifiers WCi (i=1 through N), which are linearly linked in a cascade configuration. It is preferable for the classifiers 43 through 45 to have higher discrimination accuracy than the classifiers 33 through 35 of the first face detecting section 30. The outline of the processes performed by the second face detecting section 40 and the processes performed by the weak classifiers are basically the same as those performed by the first face detecting section 30. However, the positions at which the subwindows W are set are limited to positions within predetermined regions that include the face candidates S2. In addition, the increment of movement of the subwindows W is finer than in the case of the first face detecting section 30, for example, 1 pixel. Thereby, the face candidates S2, which have been roughly extracted by the first face detecting section 30 are narrowed down, and only true faces S3 are output.

The redundant detection discriminating section 50 organizes faces, which have been redundantly detected within the resolution images S1′_{—}i, as single faces S3′, based on positional data of the faces S3 detected therein. Then, the redundant detection discriminating section 50 outputs positional data of the faces S3′, which have been detected within the input images S0. The reason why the faces S3 are organized is as follows. Depending on learning methods, classifiers are capable of detecting faces within a range of sizes. Therefore, there are cases in which the same face is redundantly detected within a plurality of resolution images having adjacent resolution levels.

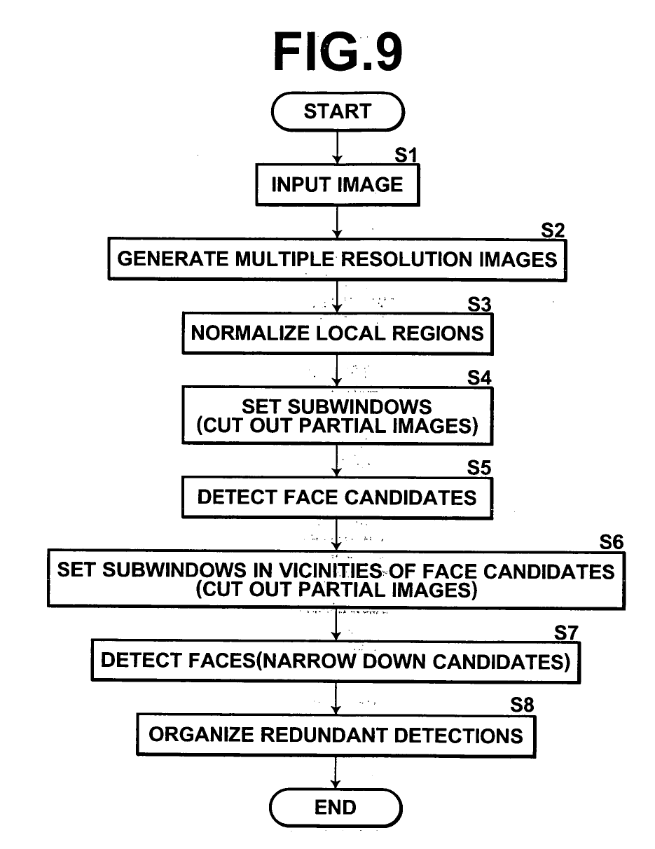

FIG. 9 is a flow chart that illustrates the processes performed by the face detecting system 1. As illustrated in FIG. 9, when an input image S0 is input (step S1) to the multiple resolution image generating section 10, the input image S0 is converted to an image S1 of the predetermined size, and a plurality of resolution images S1_{—}i, which decrease in resolution by factors of 2^{-1/3}, are generated from the image S1 (step S2). Next, the local region normalizing section 20 administers the local region normalizing process for suppressing fluctuations in contrast at local regions, to the entireties of each of the resolution images S1_{—}i. That is, normalization is administered by converting brightness gradations of local regions, having degrees of variance of pixel values greater than or equal to the threshold value, such that the degree of variance approach the second predetermined level, and by converting brightness gradations of local regions, having degrees of variance of pixel values less than the threshold value, such that the degrees of variance are suppressed to be lower than the second predetermined level, thereby obtaining the normalized resolution images S1′_{—}i (step S3). The first subwindow setting section 31 of the first face detecting section 30 sequentially cuts out partial images according to the set subwindows W from the normalized resolution images S1′_{—}i (step S4). Then, the first forward facing face classifier 33, the first left profile face classifier 34, and the first right profile face classifier 35 perform discriminations with respect to each of the partial images, to roughly detect face candidates S2 within the resolution images S1′_{—}i (step S5). Further, the second face detecting section 40 cuts out partial images according to the subwindows W from the vicinities of the face candidates S2 detected in step S5. Then, face detection is performed by the second forward facing face classifier 43, the second left profile face classifier 44, and the second right profile face classifier 45, to narrow down the face candidates S2 into true faces S3 (step S7). Thereafter, single faces, which have been redundantly detected within the resolution images S1′_{—}i are organized (step S8), and the single faces are output as the detected faces S3′.

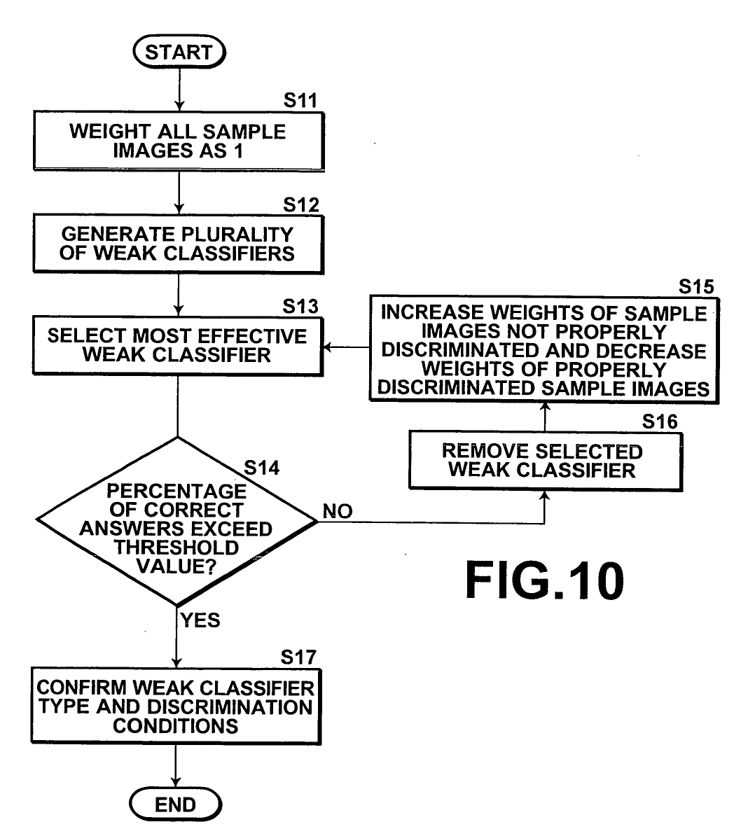

Next, the learning method for the classifiers will be described. FIG. 10 is a flow chart that illustrates the learning method for the classifiers. Note that the learning process is performed for each type of classifier, that is, for each direction that the faces to be detected are facing.

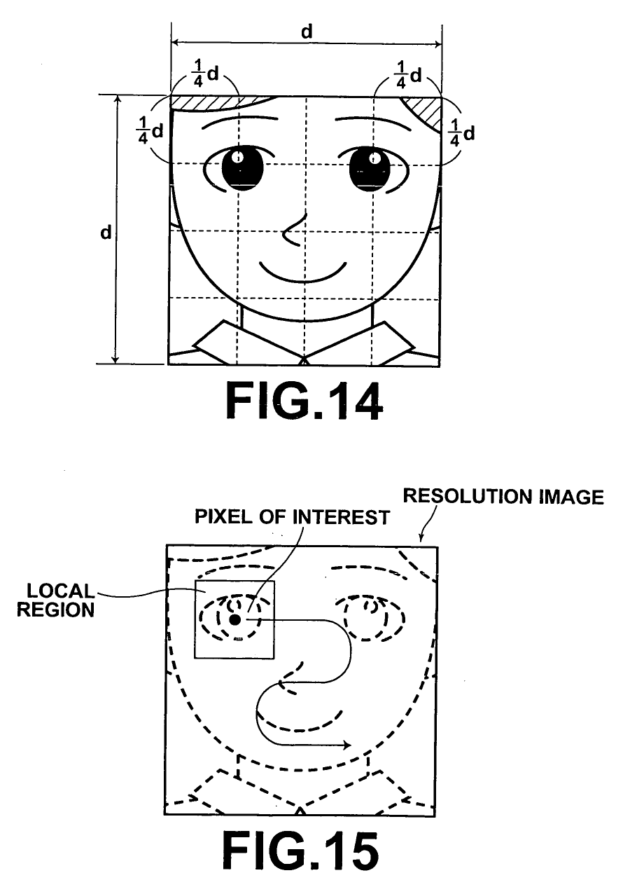

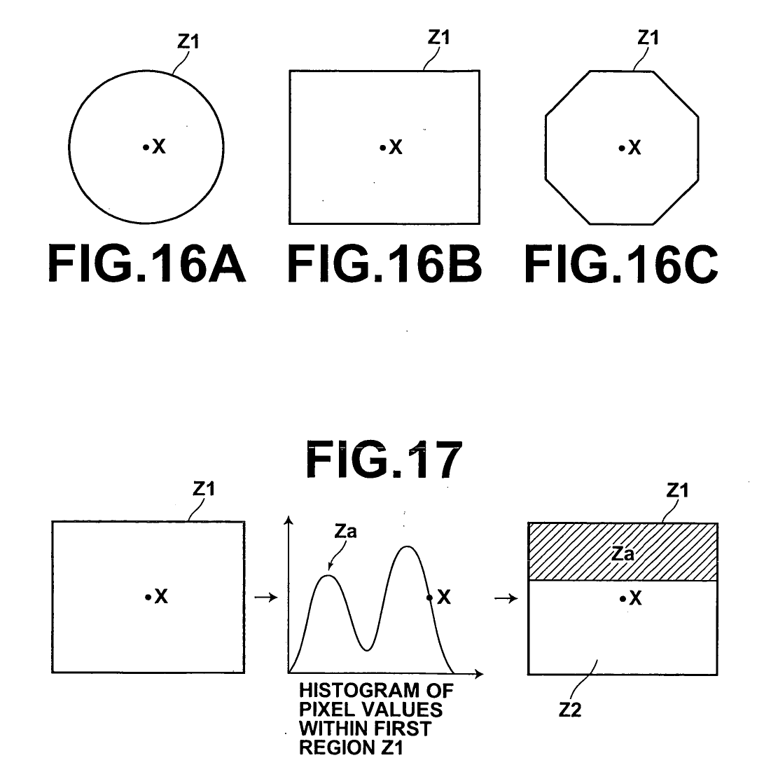

A sample image group, which is the subject of learning, comprises a plurality of sample images, which are known to be of faces, and a plurality of sample images, which are known to not be of faces. The sample images are standardized to be of a predetermined size, for example, 32×32 pixels. Note that in the sample images, which are known to be of faces, the direction that the faces to be detected by each classifier are facing are matched, as well as the vertical orientations thereof. Variations of each sample image, which are known to be of faces, are employed. That is, the vertical and/or horizontal dimensions of each sample image are enlarged/reduced at 0.1× increments within a range of 0.7× to 1.2×. Each of the enlarged/reduced sample images are also rotated in three degree increments within a range of ±15 degrees within the planes thereof. Note that at this time, the sizes and positions of the sample images of faces are standardized such that the eyes therein are at predetermined positions. The enlargement/reduction and rotation are performed with the positions of the eyes as the reference points. For example, in the case of a sample image in which a forward facing face is pictured, the size and the position of the face are standardized such that the positions of the eyes are d/4 down and d/4 toward the interior from the upper left and upper right corners of the image, as illustrated in FIG. 14. The rotation and enlargement/reduction are performed with the center point between the eyes as the center of the image. Each sample image is weighted, that is, is assigned a level of importance. First, the initial values of weighting of all of the sample images are set equally to 1 (step S11).

Next, weak classifiers are generated for each of a plurality of different pair groups, constituted by pairs of points which are set within the planes of the sample images and the enlarged/reduced sample images (step S12). Here, each weak classifier has a function of providing a reference to discriminate images of faces from those not of faces, by employing combinations of the differences between pixel values (representing brightness) of each pair of points that constitute the pair group. In the present embodiment, histograms of combinations of the differences between each pair of points that constitutes a single pair group are utilized as the bases for score tables for each weak classifier.

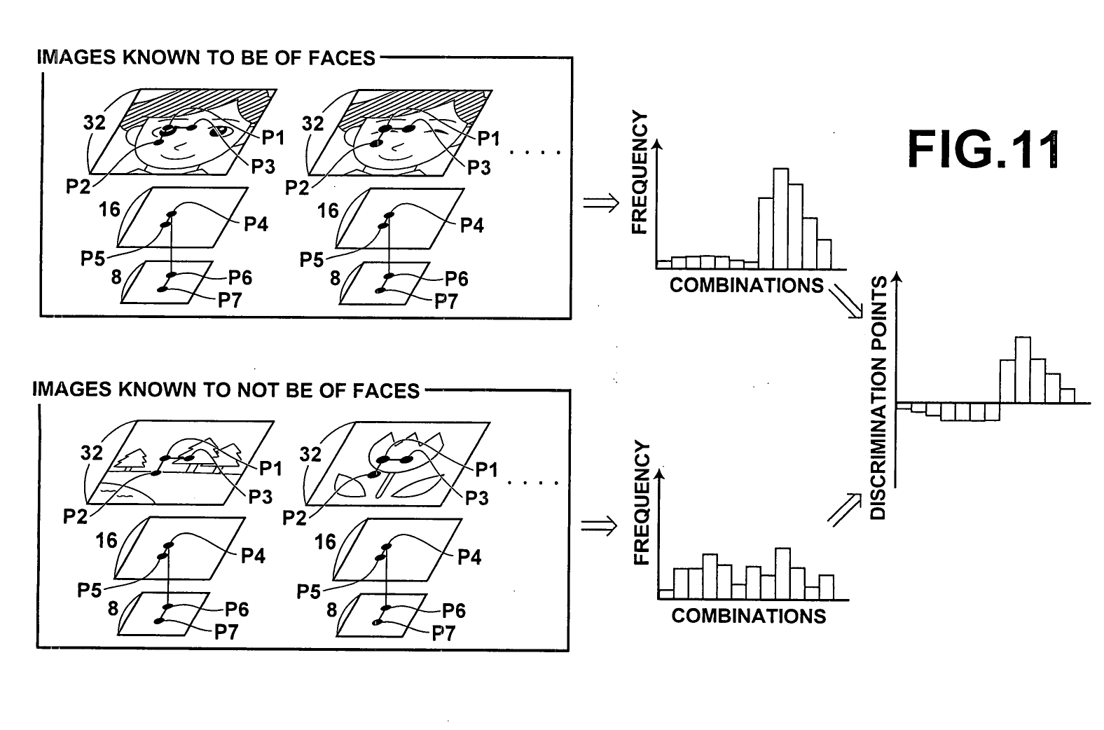

The generation of a weak classifier will be described with reference to FIG. 11. As illustrated in the sample images at the left side of FIG. 11, the pairs of points that constitute the pair group for generating the weak classifier are five pairs, between points P1 and P2, P1 and P3, P4 and P5, P4 and P6, and P6 and P7. The point P1 is located at the center of the right eye, the point P2 is located within the right cheek, and the point P3 is located within the forehead of the sample images. The point P4 is located at the center of the right eye, and the point P5 is located within the right cheek, of a 16×16 pixel size image, obtained by administering the four neighboring pixel average process on the sample image. The point P5 is located at the center of the right eye, and the point P7 is located within the right cheek, of an 8×8 pixel size image, obtained by administering the four neighboring pixel average process on the 16×16 pixel size image. Note that the coordinate positions of the pairs of points that constitute a single pair group for generating a single weak classifier are the same within all of the sample images. Combinations of the differences between the pixel values of each of the five pairs of points that constitute the pair group are calculated for all of the sample images, and a histogram is generated. Here, the values of the combinations of differences between pixel values depend on the number of brightness gradations. In the case that the number of brightness gradations is expressed as 16 bit data, there are 65536 possible differences for each pair of pixel values. Therefore, there are 65536 to the (number of pairs) power, as total possible values of the combinations. In this case, there are 655365 possible values, which would require a great number of samples, a great amount of time, and a great amount of memory to execute learning and detection. Therefore, in the present embodiment, the differences between the pixel values are sectioned at appropriate widths of numerical values, to quantify them into n values (n=100, for example).

Thereby, the number of combinations of differences between pixel values becomes n⁵, and the amount of data that represents the differences between pixel values can be reduced.

In a similar manner, histograms are generated for the plurality of sample images, which are known to not be of faces. Note that in the sample images, which are known to not be of faces, points (denoted by the same reference numerals P1 through P7) at positions corresponding to the pixels P1 through P7 of the sample images, which are known to be of faces, are employed in the calculation of the differences between pixel values. Logarithms of the ratios of the frequencies in the two histograms are represented by the rightmost histogram illustrated in FIG. 11, which is employed as the basis for the score table of the weak classifier. The values along the vertical axis of the histogram of the weak classifier will be referred to as discrimination points. According to the weak classifier, images that have distributions of the combinations of differences between pixel values corresponding to positive discrimination points therein are highly likely to be of faces. The likelihood that an image is of a face increases with an increase in the absolute values of the discrimination points. On the other hand, images that have distributions of the combinations of differences between pixel values corresponding to negative discrimination points are highly likely to not be of faces. Again, the likelihood that an image is not of a face increases with an increase in the absolute values of the negative discrimination points. A plurality of weak classifiers are generated in histogram format regarding combinations of the differences between pixel values of pairs of the plurality of types of pair groups in step S12.

Thereafter, a weak classifier, which is most effective in discriminating whether an image is of a face, is selected from the plurality of weak classifiers generated in step S12. The selection of the most effective weak classifier is performed while taking the weighting of each sample image into consideration. In this example, the percentages of correct discriminations provided by each of the weak classifiers are compared, and the weak classifier having the highest weighted percentage of correct discriminations is selected (step S13). At the first step S3, all of the weighting of the sample images are equal, at 1. Therefore, the weak classifier that correctly discriminates whether sample images are of faces with the highest frequency is selected as the most effective weak classifier. On the other hand, the weightings of each of the sample images are renewed at step S15, to be described later. Thereafter, the process returns to step S13. Therefore, at the second step S13, there are sample images weighted with 1, those weighted with a value less than 1, and those weighted with a value greater than 1. Accordingly, during evaluation of the percentage of correct discriminations, a sample image, which has a weighting greater than 1, is counted more than a sample image, which has a weighting of 1. For these reasons, from the second and subsequent step S13's, more importance is placed on correctly discriminating heavily weighted sample images than lightly weighted sample images.

Next, confirmation is made regarding whether the percentage of correct discriminations of a combination of the weak classifiers which have been selected, that is, weak classifiers that have been utilized in combination (it is not necessary for the weak classifiers to be linked in a linear configuration in the learning stage) exceeds a predetermined threshold value (step S14). That is, the percentage of discrimination results regarding whether sample images are of faces, which are obtained by the combination of the selected weak classifiers, that match the actual sample images is compared against the predetermined threshold value. Here, the sample images, which are employed in the evaluation of the percentage of correct discriminations, may be those that are weighted with different values, or those that are equally weighted. In the case that the percentage of correct discriminations exceeds the predetermined threshold value, whether an image is of a face can be discriminated by the selected weak classifiers with sufficiently high accuracy, therefore the learning process is completed. In the case that the percentage of correct discriminations is less than or equal to the predetermined threshold value, the process proceeds to step S16, to select an additional weak classifier, to be employed in combination with the weak classifiers which have been selected thus far.

The weak classifier, which has been selected at the immediately preceding step S13, is excluded from selection in step S16, so that it is not selected again.

Next, the weighting of sample images, which were not correctly discriminated by the weak classifier selected at the immediately preceding step S13, is increased, and the weighting of sample images, which were correctly discriminated, is decreased (step S15). The reason for increasing and decreasing the weighting in this manner is to place more importance on images which were not correctly discriminated by the weak classifiers that have been selected thus far. In this manner, selection of a weak classifier which is capable of correctly discriminating whether these sample images are of a face is encouraged, thereby improving the effect of the combination of weak classifiers.

Thereafter, the process returns to step S13, and another effective weak classifier is selected, using the weighted percentages of correct discriminations as a reference.

The above steps S13 through S16 are repeated to select weak classifiers corresponding to combinations of the differences between pixel values for each pair that constitutes specific pair groups, which are suited for discriminating whether faces are included in images. If the percentages of correct discriminations, which are evaluated at step S14, exceed the threshold value, the type of weak classifier and discrimination conditions, which are to be employed in discrimination regarding whether images include faces, are determined (step S17), and the learning process is completed. In addition, a score table, for calculating scores according to combinations of differences between pixel values, is generated for each weak classifier, based on the histograms therefor. Note that the histograms themselves may be employed as the score tables. In this case, the discrimination points of the histograms become the scores.

Note that in the case that the learning technique described above is applied, the weak classifiers are not limited to those in the histogram format. The weak classifiers may be of any format, as long as they provide references to discriminate between images of faces and other images by employing combinations of the differences between pixel values of each pair that constitutes specific pair groups. Examples of alternative weak classifiers are: binary data, threshold values, functions, and the like. As a further alternative, a histogram that represents the distribution of difference values between the two histograms illustrated in the center of FIG. 11 may be employed, in the case that the weak classifiers are of the histogram format.

The learning technique is not limited to that which has been described above. Other machine learning techniques, such as a neural network technique, may be employed.

Here, the optimal size to be set for the local regions, which are employed during the local region normalizing process by the local region normalizing section 20, will be considered.

The local region normalizing process, as described above, is a process for suppressing local fluctuations in contrast within the partial images cut out by the subwindow W. Specifically, the local region normalizing section 20 sets each pixel within the partial images as a pixel of interest. Next, the variance among pixel values within a local region of a predetermined size having the pixel of interest at its center is calculated. The difference between the pixel value of the pixel of interest and the mean value of pixel values within the local region (or any other statistically representative value) is caused to become smaller, as the difference between the variance and the reference value become greater. when the variance is greater than the reference value. The difference between the pixel value of the pixel of interest and the mean value is caused to become greater, as the difference between the variance and the reference value become greater, when the variance is less than the reference value.

In this local region normalizing process, the degree of local suppression of fluctuations in contrast is determined by the size of the local region. Commonly, fluctuations in brightness can be suppressed better the greater the size of the local region is, while variations in fine contrast become difficult to suppress. Meanwhile, variations in fine contrast can be suppressed better the smaller the size of the local region is, while fluctuations in brightness become difficult to suppress. In addition, in the case that all or some elements that constitute a face are included within the local region, the variance in pixel values reacts sensitively to the pixel value of the nose or to the percentage of the area of the local region that the nose occupies. As a result, pixel values of eyes, which are positioned at the center of the local region, may fluctuate in an unnatural manner. When pixel values of predetermined constituent elements fluctuate unnaturally, the characteristic amounts related to the brightness within the discrimination target image do not appropriately reflect the likelihood that the image represents a face. Therefore, the accuracy of discrimination is reduced.

Accordingly, by taking the aforementioned properties and problems associated with the local region normalizing process, as well as the fact that the local region normalizing process is a preliminary process administered prior to the face detecting process into consideration, the optimal size of the local region would be as follows. The optimal size of the local region is that which favorably balances the degree of variations in contrast and the degree of fluctuations in brightness that can be suppressed, and prevents different constituent elements from being included therein simultaneously. A local region of a size that employs an “eye”, which is the smallest constituent element that represents the characteristics of a face, satisfies these requirements. Therefore, the local region can be set to a size that includes a single eye, which is to be discriminated by the weak classifiers. Note that the size of the eye to be discriminated by the weak classifiers utilizes the sizes of the eyes of faces pictured in the sample images employed in the learning process as references. Therefore, the size of the local region may have widths which are 1.1 to 1.8 times the average width of the widths of eyes included in the sample facial images. The size of the local regions employed in the local region normalizing process administered by the local region normalizing section 20 of the present embodiment, that is, the 11×11 pixel size, is an example of a size which is set based on the aforementioned points.

In this manner, the face discriminating method and the face discriminating apparatus of the present embodiment administers a normalizing process for suppressing fluctuations in contrast within a discrimination target image, by administering brightness gradation conversion to cause degrees of variance of pixel values that represent values within local regions within the discrimination target image to approach the first predetermined level. The local regions are set to be of a size that includes a single eye. Therefore, variations in contrast within constituent elements of faces, such as eyes and noses, can be suppressed. At the same time, stable normalization which is not influenced by fluctuations in density due to objects overlapping faces, oblique light, or backgrounds is enabled. Accordingly, the characteristic amounts related to the brightness distribution of a discrimination target image accurately reflect the likelihood of being a facial image, and deterioration in discrimination accuracy can be suppressed.

A preferred embodiment of the face discriminating method and the face discriminating apparatus has been described above. A program that causes a computer to execute the processes administered by the face discriminating apparatus (the local region normalizing section and the discriminating section) is also an embodiment of the present invention. Further, a computer readable medium in which such a program is recorded is also an embodiment of the present invention.

What is claimed is:

1. A face discriminating method, comprising:
a normalizing step for suppressing fluctuations in contrast within a discrimination target image, which is a target of discrimination regarding whether the image is a facial image, by administering brightness gradation conversion to cause degrees of variance of pixel values that represent values within local regions within the discrimination target image to approach a first predetermined level; and
a face discriminating step for calculating at least one characteristic amount related to the brightness distribution of the discrimination target image, on which the normalizing step has been administered, and discriminating whether the discrimination target image is a facial image by employing the characteristic amount;
the local regions being of a size that includes only one eye of a face to be discriminated by the face discriminating step.

2. A face discriminating method as defined in claim 1, wherein the normalizing step comprises the processes of:
sequentially setting each pixel within the discrimination target image as a pixel of interest;
calculating degrees of variance within local regions of a predetermined size, of which the pixels of interest are representative pixels; and
causing the differences between the pixel values of the pixels of interest and predetermined statistical representative pixel values of the local regions to become smaller, as the difference between the degrees of variance and a reference value corresponding to the first predetermined level become greater when the degrees of variance are greater than the reference value, and causing the differences between the pixel values of the pixels of interest and the predetermined statistical representative pixel values of the local regions to become greater, as the difference between the degrees of variance and the reference value become greater, when the degrees of variance are less than the reference value.

3. A face discriminating method as defined in claim 1, wherein:
the face discriminating step comprises learning, employing sample facial images, in which the directions that the faces pictured therein are facing and the vertical orientations thereof are the same; and
the local regions are regions having widths which are 1.1 to 1.8 times the average width of the widths of eyes included in the sample facial images.

4. A face discriminating method as defined in claim 2, wherein:
the face discriminating step comprises learning, employing sample facial images, in which the directions that the faces pictured therein are facing and the vertical orientations thereof are the same; and
the local regions are regions having widths which are 1.1 to 1.8 times the average width of the widths of eyes included in the sample facial images.

5. A face discriminating method as defined in claim 1, wherein:
the face discriminating step comprises a plurality of different discriminating steps for discriminating whether the discrimination target image is a facial image, which are linearly linked in order of reliability thereof.

6. A face discriminating method as defined in claim 1, wherein:
the predetermined statistically representative value of the pixel values is one of an mean value, a median value, an intermediate value, and a mode value.

7. A face discriminating apparatus, comprising:
normalizing means for administering a normalizing process to suppress fluctuations in contrast within a discrimination target image, which is a target of discrimination regarding whether the image is a facial image, by administering brightness gradation conversion to cause degrees of variance of pixel values that represent values within local regions within the discrimination target image to approach a first predetermined level; and
face discriminating means for calculating at least one characteristic amount related to the brightness distribution of the discrimination target image, on which the normalizing step has been administered, and discriminating whether the discrimination target image is a facial image by employing the characteristic amount;
the local regions being of a size that includes only one eye of a face to be discriminated by the face discriminating means.

8. A face discriminating apparatus as defined in claim 7, wherein the normalizing process comprises the steps of:
sequentially setting each pixel within the discrimination target image as a pixel of interest;
calculating degrees of variance within local regions of a predetermined size, of which the pixels of interest are representative pixels; and
causing the differences between the pixel values of the pixels of interest and predetermined statistical representative pixel values of the local regions to become smaller, as the difference between the degrees of variance and a reference value corresponding to the first predetermined level become greater when the degrees of variance are greater than the reference value, and causing the differences between the pixel values of the pixels of interest and the predetermined statistical representative pixel values of the local regions to become greater, as the difference between the degrees of variance and the reference value become greater, when the degrees of variance are less than the reference value.

9. A face discriminating apparatus as defined in claim 7, wherein:
the face discriminating means performs learning, employing sample facial images, in which the directions that the faces pictured therein are facing and the vertical orientations thereof are the same; and
the local regions are regions having widths which are 1.1 to 1.8 times the average width of the widths of eyes included in the sample facial images.

10. A face discriminating apparatus as defined in claim 8, wherein:
the face discriminating means performs learning, employing sample facial images, in which the directions that the faces pictured therein are facing and the vertical orientations thereof are the same; and
the local regions are regions having widths which are 1.1 to 1.8 times the average width of the widths of eyes included in the sample facial images.

11. A face discriminating apparatus as defined in claim 7, wherein:
the face discriminating means comprises a plurality of different weak classifiers for discriminating whether the discrimination target image is a facial image, which are linearly linked in order of reliability thereof.

12. A face discriminating apparatus as defined in claim 7, wherein:
the predetermined statistically representative value of the pixel values is one of an mean value, a median value, an intermediate value, and a mode value.

13. A computer readable medium having a program stored therein, the program causing a computer to execute:
a normalizing procedure for suppressing fluctuations in contrast within a discrimination target image, which is a target of discrimination regarding whether the image is a facial image, by administering brightness gradation conversion to cause degrees of variance of pixel values that represent values within local regions within the discrimination target image to approach a first predetermined level; and
a face discriminating procedure for calculating at least one characteristic amount related to the brightness distribution of the discrimination target image, on which the normalizing step has been administered, and discriminating whether the discrimination target image is a facial image by employing the characteristic amount;
the local regions being of a size that includes only one eye of a face to be discriminated by the face discriminating procedure.

14. A computer readable medium as defined in claim 13, wherein the normalizing procedure comprises the processes of:
sequentially setting each pixel within the discrimination target image as a pixel of interest;
calculating degrees of variance within local regions of a predetermined size, of which the pixels of interest are representative pixels; and
causing the differences between the pixel values of the pixels of interest and predetermined statistical representative pixel values of the local regions to become smaller, as the difference between the degrees of variance and a reference value corresponding to the first predetermined level become greater when the degrees of variance are greater than the reference value, and causing the differences between the pixel values of the pixels of interest and the predetermined statistical representative pixel values of the local regions to become greater, as the difference between the degrees of variance and the reference value become greater, when the degrees of variance are less than the reference value.

15. A computer readable medium as defined in claim 13, wherein:
the face discriminating procedure comprises learning, employing sample facial images, in which the directions that the faces pictured therein are facing and the vertical orientations thereof are the same; and
the local regions are regions having widths which are 1.1 to 1.8 times the average width of the widths of eyes included in the sample facial images.

16. A computer readable medium as defined in claim 14, wherein:
the face discriminating procedure comprises learning, employing sample facial images, in which the directions that the faces pictured therein are facing and the vertical orientations thereof are the same; and
the local regions are regions having widths which are 1.1 to 1.8 times the average width of the widths of eyes included in the sample facial images.

17. A computer readable medium as defined in claim 13, wherein:
the face discriminating procedure comprises a plurality of different discriminating steps for discriminating whether the discrimination target image is a facial image, which are linearly linked in order of reliability thereof.

18. A computer readable medium as defined in claim 13, wherein:
the predetermined statistically representative value of the pixel values is one of an mean value, a median value, an intermediate value, and a mode value.
